(19) United States
(12) Patent Application Publication
(10) Pub. No.: US 2014/0175050 A1
(43) Pub. Date: Jun. 26, 2014

(54) METHOD FOR PROVIDING A MAGNETIC RECORDING TRANSDUCER INCLUDING A WRAPAROUND SHIELD AND A RECTANGULAR POLE

(71) Applicant: WESTERN DIGITAL (FREMONT), LLC, Fremont, CA (US)

(72) Inventors: JINQIU ZHANG, Fremont, CA (US); XIAOYU YANG, Union City, CA (US); FENG LIU, San Ramon, CA (US); MING JIANG, San Jose, CA (US); TSUNG YUAN CHEN, San Ramon, CA (US)

(73) Assignee: WESTERN DIGITAL (FREMONT), LLC, Fremont, CA (US)

(21) Appl. No.: 13/724,213

(22) Filed: Dec. 21, 2012

(51) Int. Cl. G11B 5/127

(52) U.S. Cl. CPC G11B 5/127
USPC 216/22

(57) ABSTRACT

A method fabricates a magnetic transducer having an ABS location. Etch stop and nonmagnetic etchable layers are provided. A side shield layer is provided between the ABS location and the etch stop and etchable layers. Part of the side shield and etchable layers are removed using a first removal process. This portion of the pole trench formed has a top wider than the bottom in the side shield layer. Part of the etchable layer is removed using a second removal process, thereby forming the pole trench. The pole trench has a bottom and a top wider than the bottom in the side shield layer and substantially perpendicular sidewalls in the etchable layer. A nonmagnetic side gap layer is provided. A remaining portion of the pole trench has a location and profile for a pole. At least part of the pole is in the pole trench.

### BACKGROUND

FIG. 1 is a flow chart depicting a conventional method 10 for fabricating for a conventional magnetic recording transducer including a full wraparound shield. For simplicity, some steps are omitted. Prior to the conventional method 10 starting, underlayers such as a leading edge shield may be formed. The conventional method 10 typically starts by providing a pole, such as a perpendicular magnetic recording (PMR) pole, via step 12. Step 12 includes fabricating the pole in a nonmagnetic layer, such as aluminum oxide. For example, a process that forms a trench in the aluminum oxide layer, deposits nonmagnetic side gap/seed layers, and deposits magnetic pole layers may be used. In addition, the portion of the magnetic material external to the trench may be removed, for example using a chemical mechanical planarization (CMP) process.

The exposed aluminum oxide is wet etched, via step 14. Thus, a trench is formed around a portion of the pole near the ABS location. Note that side gap layers may remain after the aluminum oxide etch in step 14. The removal of the aluminum oxide in step 14 exposes the top surface of the leading edge shield. The side shields are then deposited, via step 16. Step 16 may include depositing seed layers and plating the side shields. Processing may then be completed, via step 18. For example, a trailing edge shield and gap may be formed.

FIG. 2 depicts an air-bearing surface (ABS) view of a portion of a conventional transducer 50 formed using the conventional method 10. The conventional transducer 50 includes a leading edge shield 52, side shield 54, Ru side gap layer 56 which is deposited in the trench, a pole 58, top gap layer 60, and trailing shield 62. Thus, using the conventional method 10, the pole 58, side shields 54, and trailing shield 62 may be formed. The leading shield 52, side shield 54 and trailing shield 62 may be considered to form a wraparound shield. Although not shown in FIG. 2, the conventional pole 58 also includes a yoke region. The yoke region typically includes sidewalls that are analogous to those at the ABS. Thus, at least part of the sidewalls in the yoke region generally have a reverse angle. Stated differently, even in the yoke region, the top of the pole 38 is typically wider than the bottom.

Although the conventional method 10 may provide the conventional transducer 50, there may be drawbacks. Formation of the conventional transducer 50 may involve numerous steps, some of which may be complex. As a result, fabrication of the conventional transducer may take a longer time than desired to complete. In addition, more complicated processing may be more error-prone. Further, other geometries for the pole 58 may be desired. The performance of the conventional transducer 50 may thus be compromised.

Accordingly, what is needed is an improved method for fabricating a transducer.

### SUMMARY

A method fabricates a magnetic transducer having a nonmagnetic layer and an ABS location corresponding to an ABS. Etch stop and nonmagnetic etchable layers are provided. A side shield layer is provided between the ABS location and the etch stop and etchable layers. A first portion of the side shield layer and first portion of the nonmagnetic etchable layer are removed using a first removal process. A first portion of a pole trench is thus formed. The first portion of the pole trench has a bottom and a top wider than the bottom in the side shield layer. At least a second portion of the nonmagnetic etchable layer is removed using a second removal process, thereby forming the pole trench. The pole trench has a pole trench bottom and a pole trench top wider than the pole trench bottom in the side shield layer and substantially perpendicular sidewalls in the nonmagnetic etchable layer. A nonmagnetic side gap layer, at least part of which is in the pole trench, is provided. A remaining portion of the pole trench has a location and profile for a pole and in which at least part of the pole is formed. A write gap and trailing shield are provided. At least part of the write gap is on the pole. At least part of the trailing shield is on the write gap.

### BRIEF DESCRIPTION OF SEVERAL VIEWS OF THE DRAWINGS

FIG. 1 is a flow chart depicting a conventional method for fabricating a magnetic recording transducer.

FIG. 2 is a diagram depicting an ABS view of a conventional magnetic transducer.

FIG. 3 is a flow chart depicting an exemplary embodiment of a method for fabricating a magnetic recording transducer including side shields.

FIGS. 4A-4C are diagrams depicting an exemplary embodiment of a magnetic transducer having side shields.

FIG. 5 is a flow chart depicting another exemplary embodiment of a method for fabricating side shields for a magnetic recording transducer.

FIGS. 6A-14F are diagrams various views an exemplary embodiment of a magnetic recording transducer during fabrication.

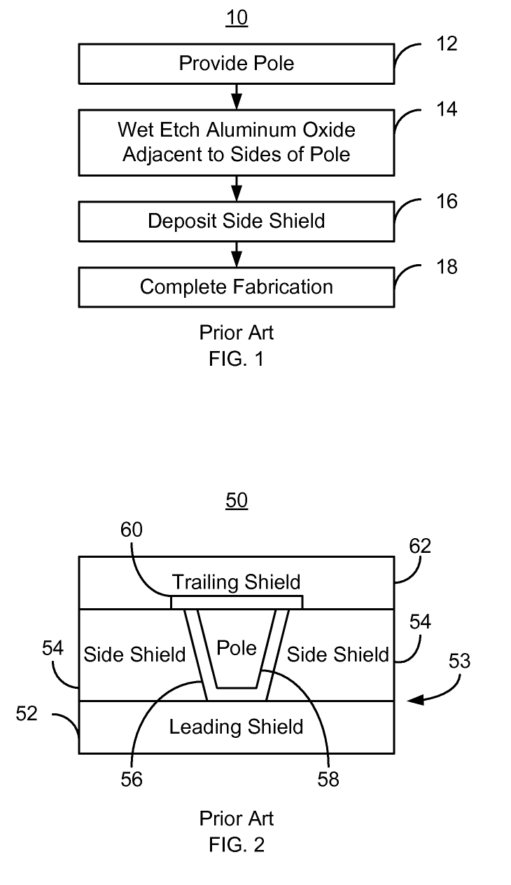

### DETAILED DESCRIPTION OF THE PREFERRED EMBODIMENTS

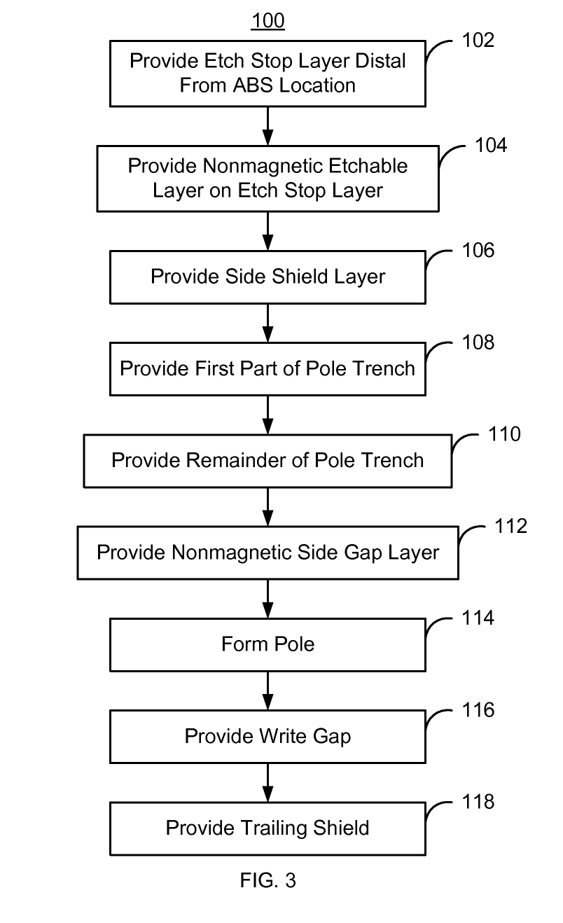

FIG. 3 is a flow chart depicting an exemplary embodiment of a method 100 for fabricating a transducer. The method 100 may be used in fabricating transducers such as PMR or energy assisted magnetic recording (EAMR) transducers, though other transducers might be so fabricated. For simplicity, some steps may be omitted, performed in another order, and/or combined. The magnetic recording transducer being fabricated may be part of a merged head that also includes a read head (not shown) and resides on a slider (not shown) in a disk drive. The method 100 also may commence after formation of other portions of the transducer. The method 100 is also described in the context of providing a single set of shields and their associated structures in a single magnetic recording transducer. However, the method 100 may be used to fabricate multiple transducers at substantially the same time. The method 100 and system are also described in the context of particular layers. However, in some embodiments, such layers may include multiple sub-layers.

An etch stop layer is provided distal from the ABS location, via step 102. The ABS location is the location at which the ABS is to be formed, for example by lapping the slider after formation of other portions of the transducer. The etch stop layer is a stop for a reactive ion etch (RIE) used in forming the pole trench, described below. In some embodiments, the etch stop layer is a Ta layer. The Ta layer may be at least ten and not more than twenty nanometers thick.

A nonmagnetic etchable layer is provided on the etch stop layer, via step 104. The nonmagnetic etchable layer is desired to be etchable using the RIE described above. The nonmagnetic etchable layer has a thickness at least as large as the desired thickness of the pole. The nonmagnetic etchable layer is desired to be etched using the same etch chemistry as the side shield layer, described below. In addition, the nonmagnetic etchable layer may be etched using an etch chemistry that does not etch the side shield layer. In some embodiments, the nonmagnetic etchable layer is SiO₂. In some embodiments, the nonmagnetic etchable layer is at least twenty and not more than sixty nanometers from the ABS location. In other embodiments, the nonmagnetic etchable layer may be another distance from the ABS location.

A side shield layer is provided, via step 106. Step 106 may include multiple substeps and/or multiple sublayers. For example, a portion of the side shield layer residing between the ABS location and the etch stop layer may be provided first. Another sublayer that is between the ABS location and the etchable layer may be provided separately. In another embodiment, the entire side shield layer may be deposited together. The side shield layer may consist of NiFe. In some embodiments, the side shield layer includes NiₓFe₁₋ₓ where x is at least 0.17 and not more than 0.7. In some embodiments, the side shield layer extends at least twenty and not more than sixty nanometers thick from the ABS location. In other embodiments, the side shield layer extends another distance from the ABS location.

A portion of the pole trench is provided in the side shield layer and the etchable layer using a first removal process, via step 108. Thus both part of the side shield layer and part of the etchable layer are removed in step 108. In some embodiments, step 108 may be completed by forming a mask having an aperture having a shape and location corresponding to the pole trench, then etching the underlying layers. In some embodiments, the mask is formed by depositing a first hard mask layer, such as NiCr and then providing a photoresist mask having the desired shape and location of the aperture. A second hard mask layer, such as Ti and/or Ta, may be deposited. The photoresist is then removed to form the aperture in the second hard mask layer. The second hard mask layer may be used to etch a corresponding aperture in the first hard mask layer. Thus, the first hard mask may be used for the etch in step 108. In other embodiments, the mask may be formed in another manner and include other materials. In some embodiments, the removal process of step 108 includes an RIE. The RIE utilizes etch conditions that are appropriate for the side shield layer and, in at least some embodiments for the etchable layer. Thus, a NiFe etch chemistry may be used. The etch chemistry may include the use of CO/NH₃ gases. Further, the etch chemistry used in step 108 forms the portion of the pole trench such that the top of the pole trench formed is wider than the bottom.

The portion of the pole trench formed in step 108 has an ABS location region and a recessed region wider and deeper than the ABS location region. In some embodiments, the recessed region extends back to the yoke region. The ABS location region is in the side shield layer, while the recessed region is in the etchable layer. Although a single etch is used in step 108, the width and depth of the trench differs between the ABS location and the recessed regions. In part, this may be due to a loading effect. For example, a mask used in step 108 may have an aperture that is narrower in the ABS location region, above the side shield layer, than in the recessed region above the etchable layer. Because of the combination of the shape of the aperture, the etch conditions used, and the composition of the etchable and side shield layers, the pole trench formed may be wider and deeper in the recessed region than in the ABS location region. In addition, the variation in width and depth of the pole trench may be smooth. In some embodiments, the top of the pole trench is wider than the bottom in at least the pole tip region. The bottom of the trench in the recessed region may be formed by the etch stop layer.

A remainder of the pole trench is provided using a second removal process, via step 110. Step 110 includes removing another portion of the nonmagnetic etchable layer using the second removal process. In some embodiments, the second removal process is an SiO₂ RIE. The etch conditions for the RIE of step 110 are formulated such that the side shield layer remains substantially intact after step 108. For example, the SiO₂ RIE may use SF₆ etch chemistry. As a result, the portion of the pole trench in the side shield layer remains with the top wider than the bottom. However, the portion of the pole trench in the recessed region may have substantially vertical sidewalls.

A nonmagnetic side gap layer is provided, via step 112. In some embodiments, step 112 includes depositing a single nonmagnetic layer. In other embodiments, multiple sublayers may be used. In some embodiments, the side gap layer includes Ru. At least a portion of the nonmagnetic side gap layer is in the pole trench. However, the pole trench is not filled by the side gap layer. A remaining portion of the pole trench has a location and profile for a pole. In some embodiments, the top of the remaining portion of the pole trench is wider than the bottom in at least the ABS location region. However, the remaining portion of the pole trench, particularly the recessed region, may have vertical or nearly vertical walls.

The pole is formed, via step 114. In some embodiments, step 114 includes providing a high saturation magnetization layer. For example, the magnetic layer may be plated. In other embodiments, multiple layers, at least some of which are magnetic, may be deposited. At least part of the magnetic material deposited in step 114 resides in the remaining portion of the pole trench. A planarization may then be performed to form the pole. At least part of the pole is in the pole trench. In some embodiments, the entire pole is in the pole trench. Because the pole is formed in the pole trench in the side shield and nonmagnetic etchable layers, the pole may be considered to be formed using a damascene process.

A write gap is provided, via step 116. At least part of the write gap is on the pole. Step 116 may include depositing at least one nonmagnetic write gap layer. In some embodiments, a portion of the nonmagnetic write gap distal from the pole may be removed.

A trailing shield may optionally be provided, via step 118. At least a portion of the trailing shield is on the write gap. In some embodiments, the trailing shield is physically and magnetically connected to the side shield. Thus, a wraparound shield may be provided. In other embodiments, the trailing shield is physically and magnetically separated from the side shields.

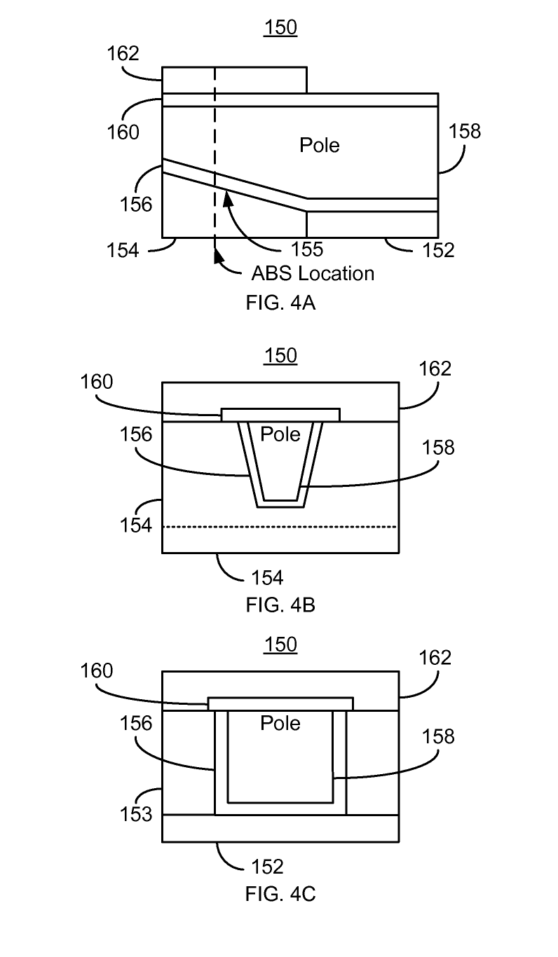

FIGS. 4A-4C depict a magnetic transducer 150 during after formation is continued using the method 100. In particular, side, ABS and recessed/yoke views are shown in FIGS. 4A, 4B and 4C, respectively. For clarity, FIGS. 4A-4C are not to scale. The magnetic transducer 150 includes an etch stop layer 152, a nonmagnetic etchable layer 153, a side shield layer 154, a nonmagnetic gap layer 156, a pole 158, a write gap 160 and a trailing shield 162. The side shield layer 154 may include multiple layers. The layers in one embodiment are indicated by the dashed line in FIG. 4B. However, in some embodiments, the layers include the same materials. In addition, although termed a side shield layer, as can be seen in FIGS. 4A and B, the layer 154 also functions as a leading shield. The nonmagnetic side gap 156 may include multiple layers. However, the sublayers of the nonmagnetic side gap layer 156 may be formed of the same material or different materials.

Using the method 100, the transducer 150 having side shields 154 may be formed. As can be seen in comparing FIGS. 4B and 4C, the geometry of the pole may be tailored. More specifically, in the region proximate to the ABS and formed in the side shields 154, the top of the pole 158 may be wider than the bottom. In contrast, the remaining, recessed portion of the pole 158 may have vertical sidewalls. As a result, the pole 158 may have improved writeability. In addition, the side shields 154, including the wraparound shield including trailing shield 162, may be more easily formed. For example, wet etches of nonmagnetic materials surrounding the pole may be omitted. Thus, the method 100 may consume less time and resources. Further, the method 100 may be less prone to unwanted artifacts in the transducer 150. Consequently, fabrication and performance of the transducer 150 may be improved.

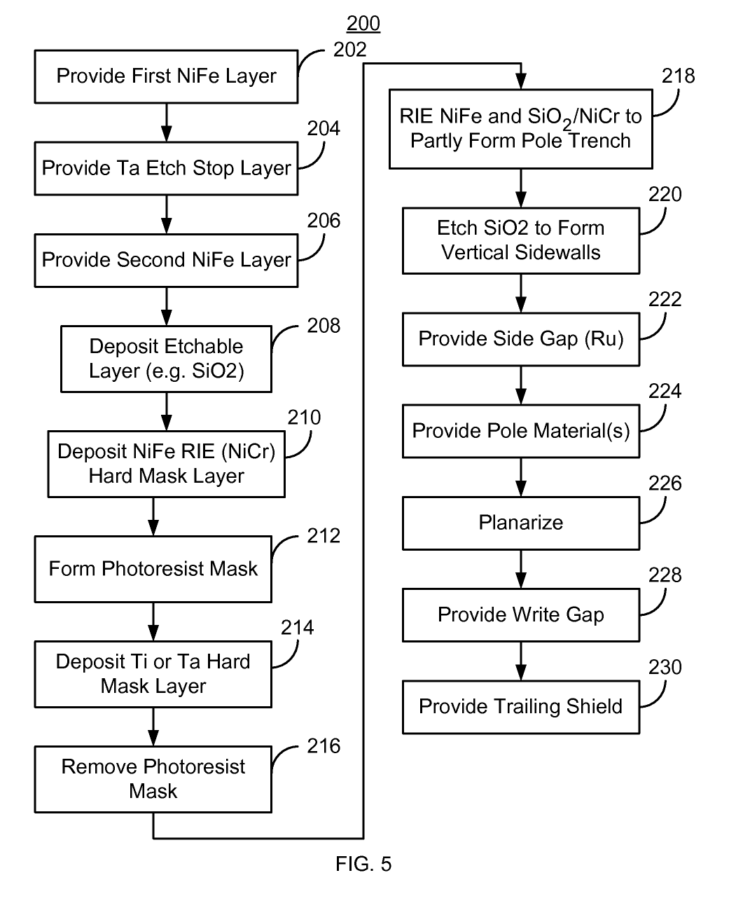

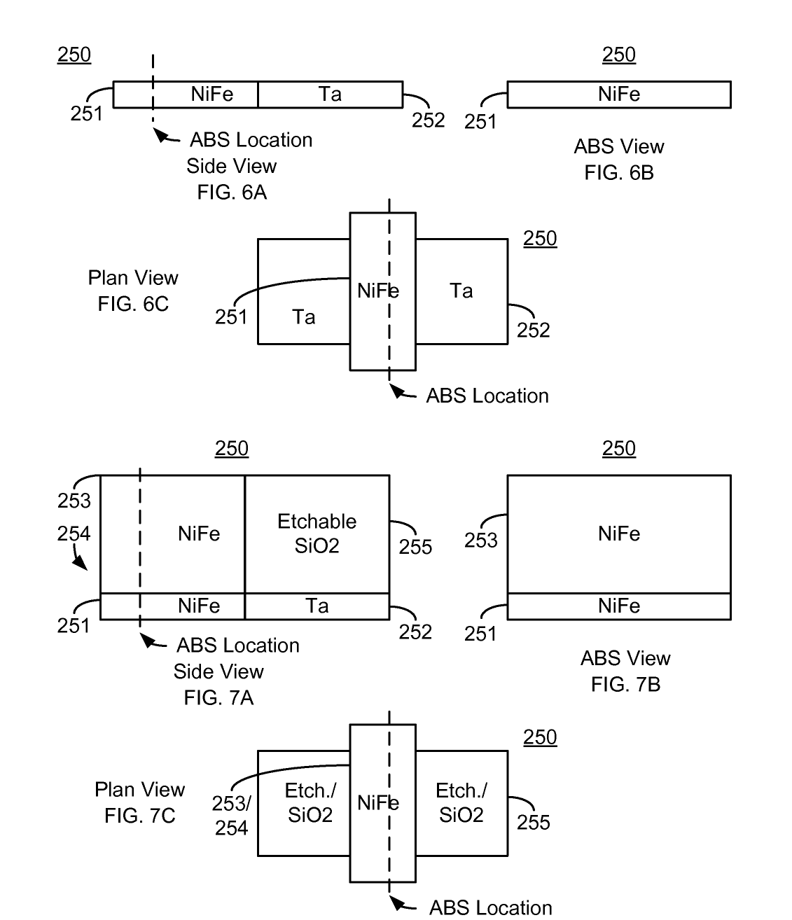

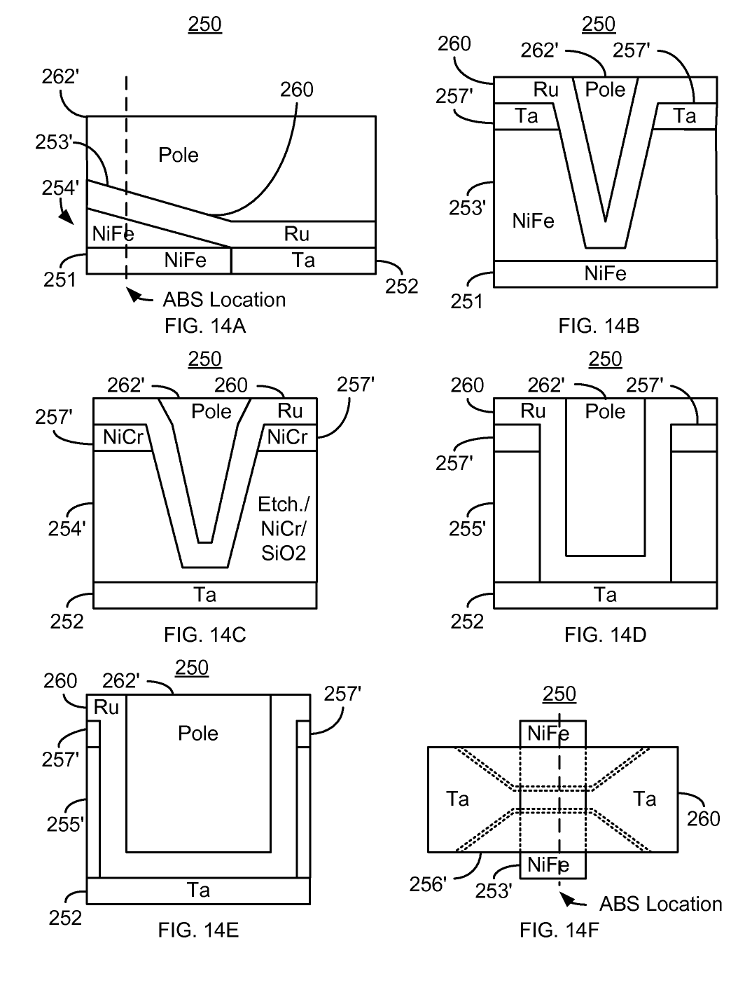

FIG. 5 is a flow chart depicting another exemplary embodiment of a method 200 for fabricating a transducer using a damascene process. For simplicity, some steps may be omitted, interleaved, and/or combined. FIGS. 6A-6C-FIGS-14A-14F are diagrams various views of an exemplary embodiment of a portion of a transducer during 250 fabrication. For clarity, 6A-6C-FIGS-14A-14F are not to scale. Although 6A-6C-FIGS. 14A-14F depict the ABS location (location at which the ABS is to be formed) and ABS at a particular point in the pole, other embodiments may have other locations for the ABS. Referring to FIGS. 5-14F, the method 200 is described in the context of the transducer 250. However, the method 200 may be used to form another device (not shown). The transducer 250 being fabricated may be part of a merged head that also includes a read head (not shown in 6A-6C-FIGS. 14A-14F) and resides on a slider (not shown) in a disk drive. The method 200 also may commence after formation of other portions of the transducer 250. The method 200 is also described in the context of providing a single transducer 250. However, the method 200 may be used to fabricate multiple transducers at substantially the same time. The method 200 and device 250 are also described in the context of particular layers. However, in some embodiments, such layers may include multiple sublayers.

A first NiFe layer is provided, via step 202. A portion of the first NiFe layer is at the ABS location. The first NiFe layer may include NiₓFe₁₋ₓ, where x is at least 0.17 and not more than 0.7. A Ta etch stop layer is provided, via step 204. The Ta etch stop layer is distal from the ABS location. Thus, the first NiFe layer is between the Ta etch stop layer and the ABS location. In some embodiments, the first NiFe layer and the Ta etch stop layer have the same thickness. For example, the first NiFe layer and the Ta etch stop layer may each be at least ten and not more than twenty nanometers thick. FIGS. 6A-6C depict side, ABS and plan views of the transducer 250 after step 204 is performed. Thus, NiFe layer 251 and Ta etch stop layer 252 are shown. Also depicted is the ABS location. A second NiFe layer is provided on the first NiFe layer, via step 206. The second NiFe layer may include NiₓFe₁₋ₓ, where x is at least 0.17 and not more than 0.7.

A nonmagnetic etchable layer is provided on the Ta etch stop layer, via step 208. In some embodiments, the etchable layer consists of SiO₂. The nonmagnetic etchable layer terminates at least twenty nanometers and not more than sixty nanometers from the ABS location. The second NiFe layer is between the etchable layer and the ABS location. FIGS. 7A, 7B and 7C depict side, ABS and plan views of the transducer 250 after step 208 is performed. Thus, a second NiFe layer 253 and the etchable layer 255 are shown. The first NiFe layer 251 and the second NiFe layer 253 form a NiFe side shield layer 254. The NiFe side shield layer 254 is between the ABS location and the Ta layer 252 and between the ABS location and the etchable layer 255. Because the etchable layer 254 includes SiO₂, the etchable layer 255 may be removed using the same RIE etch conditions as the NiFe side shield layer 254. For example a CO/NH₃ RIE may remove the nonmagnetic etchable layer 255 as well as the side shield layer 254.

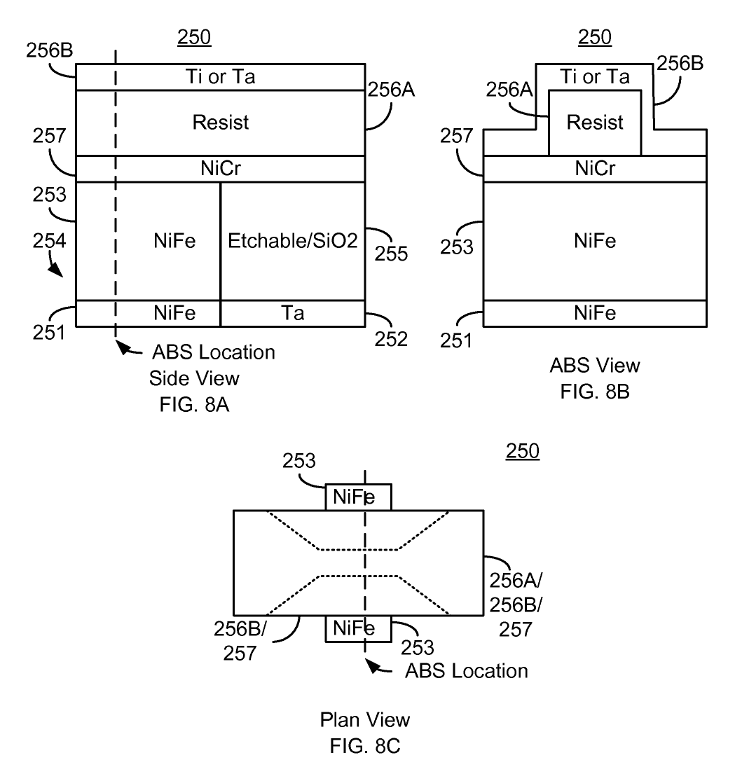

A NiFe RIE hard mask layer is deposited in step 210. In some embodiments, the NiFe RIE hard mask is NiCr. A photoresist mask corresponding to a pole trench is formed, via step 212. The photoresist mask includes a pole tip region and a yoke region wider than the pole tip region. The pole tip region includes an isolated line. An additional hard mask layer is deposited, via step 214. In some embodiments, the additional hard mask layer is a Ti and/or Ta layer. The Ti or Ta hard mask layer covers at least the NiCr hard mask layer, the photoresist mask and the region surrounding the photoresist mask. The Ti or Ta hard mask is desired to be resistant to the etch that is to be used to form an aperture in the NiCr hard mask layer. FIGS. 8A, 8B and 8C depict side, ABS and plan views of the transducer 250 after step 214 is performed. Thus, NiCr hard mask layer 257, photoresist mask 256A, and Ti or Ta hard mask layer 256B are shown.

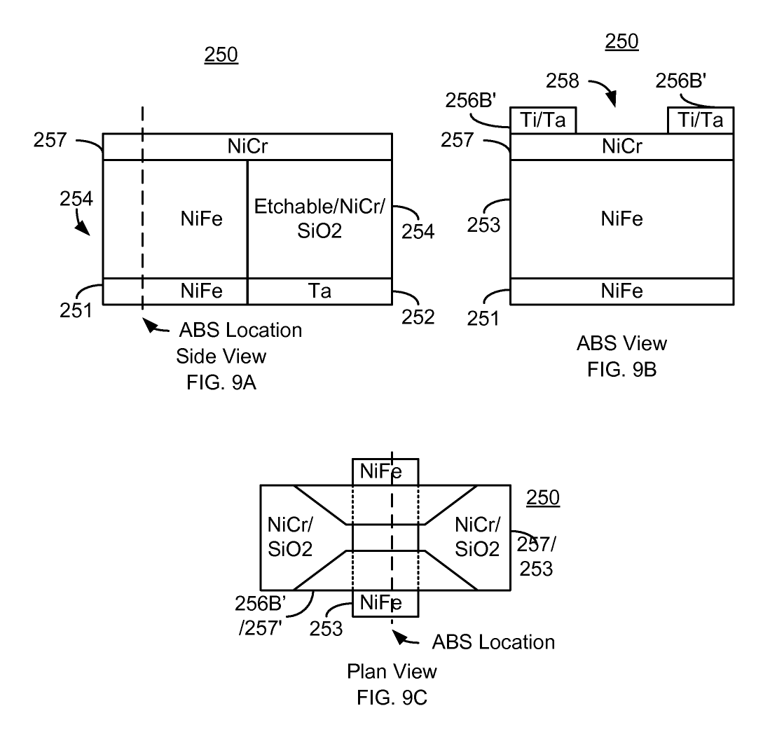

The photoresist mask 256A and a portion of the Ti or Ta hard mask layer 256B covering the photoresist mask 256A are removed, via step 216. In some embodiments, step 216 includes ion milling the Ti or Ta hard mask layer 256B at an angle to remove a portion of the Ti or Ta hard mask layer 256B on the sides of the photoresist mask 256A. A lift-off may then be performed to remove the photoresist mask 256A. As a result, any remaining Ti or Ta hard mask layer 256B on the photoresist mask 256A is removed and a Ti or Ta hard mask is formed. FIGS. 9A, 9B and 9C depict side, ABS and plan views of the transducer 250 after step 216 is performed. Thus, a Ti or Ta hard mask 256B′ has been formed. The Ti or Ta hard mask 256B′ has an aperture 258 in the location previously occupied by the photoresist mask 256A. Thus, the aperture 258 has the shape and location corresponding to the pole trench that is desired to be formed.

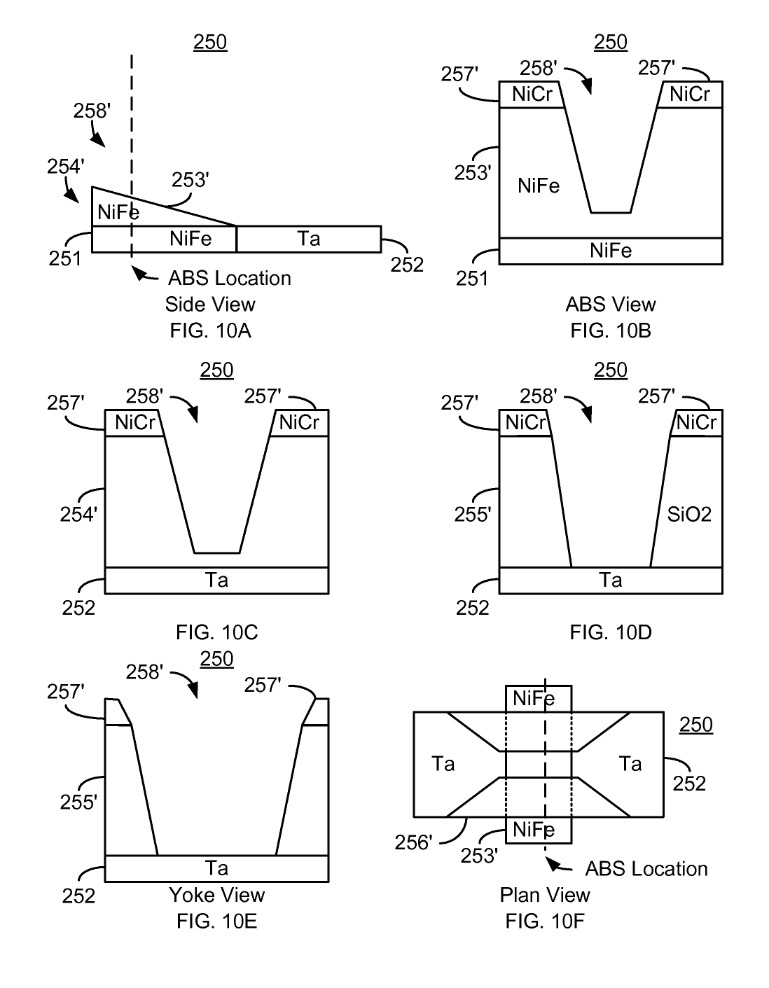

The NiFe side shield layer 254 and the etchable layer 255 exposed by the aperture 258 undergo an RIE using a NiFe etch chemistry, via step 218. In some embodiments the etch chemistry includes CO and NH₃ gases. In addition, the NiCr hard mask 257 is etched using the same chemistry. Thus, the pole trench is provided in the region of the aperture 258. Both the NiFe side shield layer 254 and the etchable layer 255 are removed using these etch conditions. FIGS. 10A, 10B, 10C, 10D, 10E and 10F depict side, ABS, two intermediate, yoke and plan views of the transducer 250 after step 218 is performed. Thus, a pole trench 258′ has been formed in the region of the aperture 258. NiCr hard mask 257′ is also formed. Portions of the second NiFe layer 253/NiFe side shield layer 254 have been removed, leaving layers 253′/254′, respectively. In addition, a portion of the etchable layer 255 has been removed. The etchable layer 255′ remains. In addition, any remaining portion of the aluminum oxide hard mask has been removed. As can be seen by comparing the views in 10B, 10C, 10D and 10E, the pole trench 258′ has a width and depth that increases away from the ABS. More specifically, in the region of the trench 258′ corresponding to the isolated line is narrower and less deep. Stated differently, the ABS location region of the pole trench 258′ in the side shield layer 254′ is less deep and narrower. This variation may be due to the combination of the shape of the aperture 258, the etch conditions used, and the composition of the etchable layer 255′ and side shield layer 254′. The depth and width of the pole trench 258′ increase and are deepest and widest in the yoke region far from the ABS location. However, even relatively close to the ABS location, for example near the transition between layers 251 and 252, the depth and width of the trench may increase. In some embodiments, as shown in FIG. 10A, this increase is smooth. However, in the recessed region, the Ta stop layer 252 forms a bottom of the pole trench 258′. Thus, although the width of the pole trench 258′ may increase in the yoke region, the depth is limited by the thickness of the etchable layer 255′.

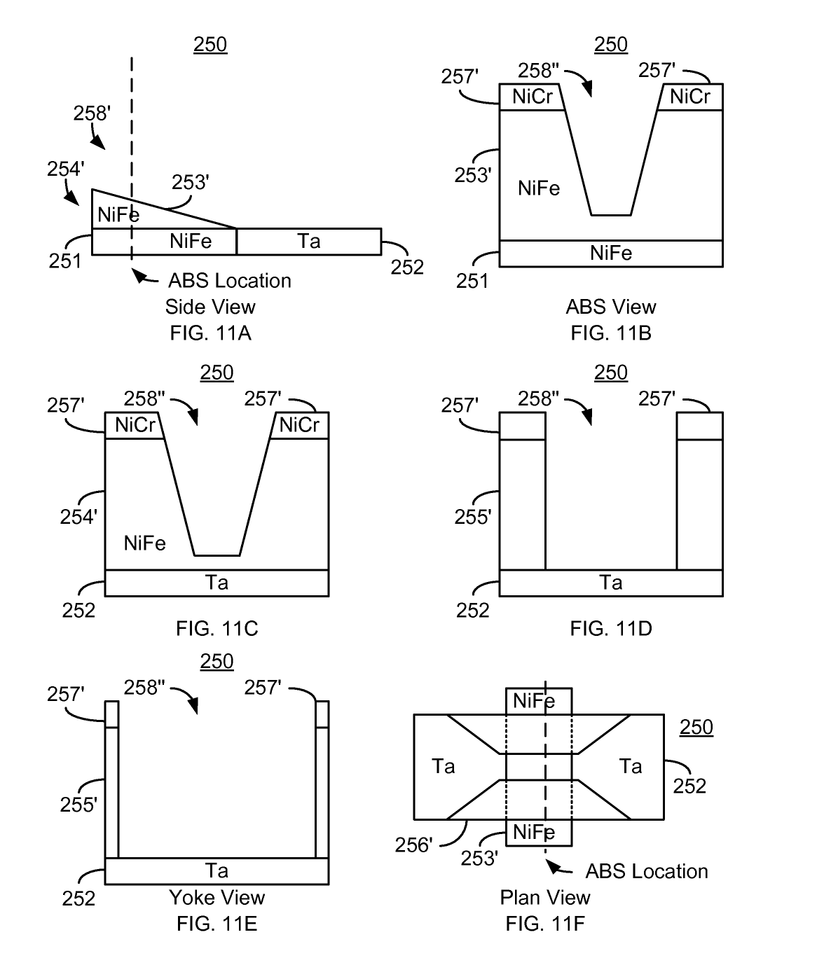

An additional etch of the nonmagnetic etchable layer is performed using a second removal process, via step 220. Formation of the pole trench is thus completed. The second removal process different from the removal process of step 218. In step 220, a silicon dioxide etch chemistry may be used. For example, SF₆ gas may be used. The etch performed in step 220 removes the nonmagnetic etchable layer 255′ without removing the side shield layer 254′. In addition, in at least some embodiments, the NiCr hard mask 257′ is not affected by the second removal process in step 220. The pole trench is thus formed. FIGS. 11A, 11B, 11C, 11D, 11E and 11F depict side, ABS, two intermediate, yoke and plan views of the transducer 250 after step 220 is performed. The formation of pole trench 258″ is thus completed. As can be seen in FIGS. 11B and 11C, the pole trench 258″ in the side shield layer 254′ still has a top wider than the bottom and angled sidewalls in the side shield layer 254′. However, as can be seen in FIGS. 11D and 11E, in the nonmagnetic etchable layer 255′, the pole trench 258″ has substantially perpendicular sidewalls. The substantially perpendicular sidewalls may commence at least twenty nanometers and not more than sixty nanometers from the ABS location, where the nonmagnetic etchable layer 255′ starts. In other embodiments, the substantially perpendicular sidewalls may start another distance from the ABS location.

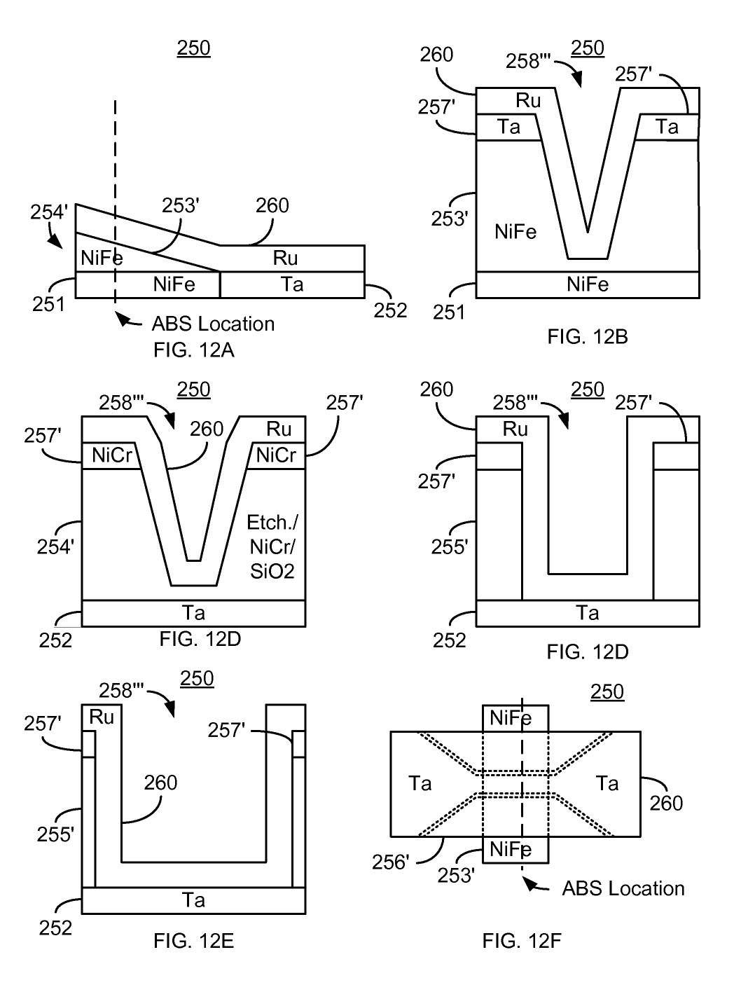

A nonmagnetic side gap layer is provided, via step 222. In some embodiments, step 222 includes depositing a single nonmagnetic layer, such as Ru. In other embodiments, multiple sublayers may be used. For example, FIGS. 12A, 12B, 12C. 12D, 12E and 12F depict side, ABS, two intermediate, yoke and plan views of the transducer 250 after a nonmagnetic gap side layer 260 has been deposited. In the embodiment shown, the side gap layer 260 is Ru that may have been deposited using chemical vapor deposition (CVD). Thus, the side gap layer 260 has substantially uniform thickness. A portion of the side gap layer 260 is within the pole trench. Thus, a remaining portion 258′″ of the pole trench is still open. FIGS. 12A, 12B, 12C, 12D, 12E and 12F depict side, ABS, two intermediate, yoke and plan views of the transducer 250 after a second side gap layer has been deposited as part of step 222. In this embodiment, the second side gap layer 260 has been deposited using chemical vapor deposition. A remaining portion 258″′ of the pole trench is still open. In the embodiment shown, the side gap layer 260 has substantially vertical sidewalls in the portion of the pole trench 258′″ in the nonmagnetic etchable layer 255′. The portion of the side gap layer 260 in the side shield layer 254′ has angled sidewalls. Consequently, the remaining portion of the pole trench 258′″ has a top wider than the bottom in the side shield layer 254′, but vertical sidewalls in the nonmagnetic etchable layer 255′.

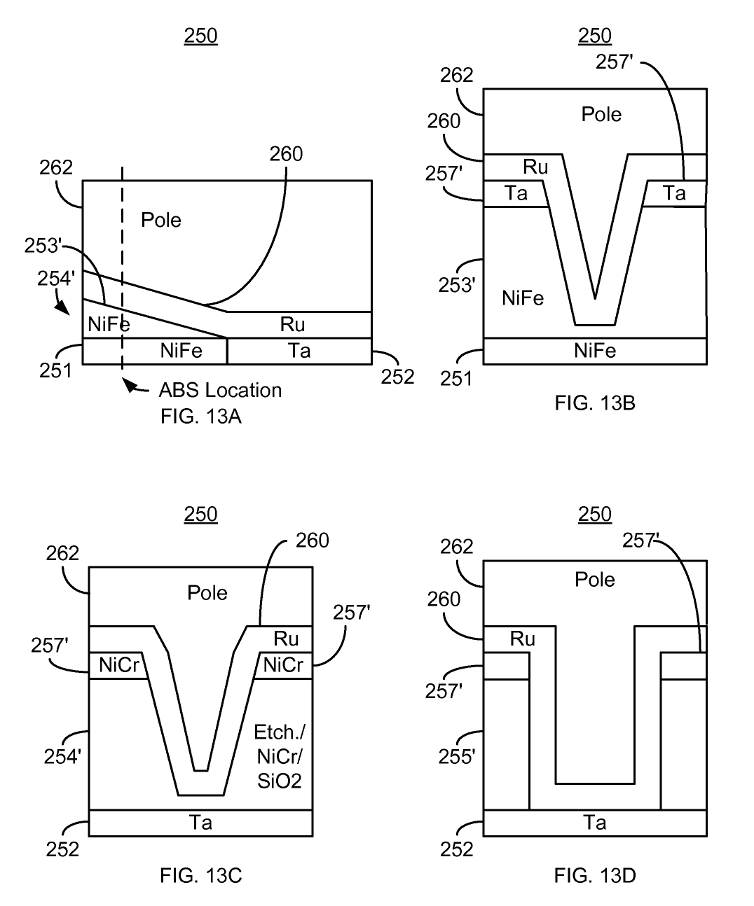

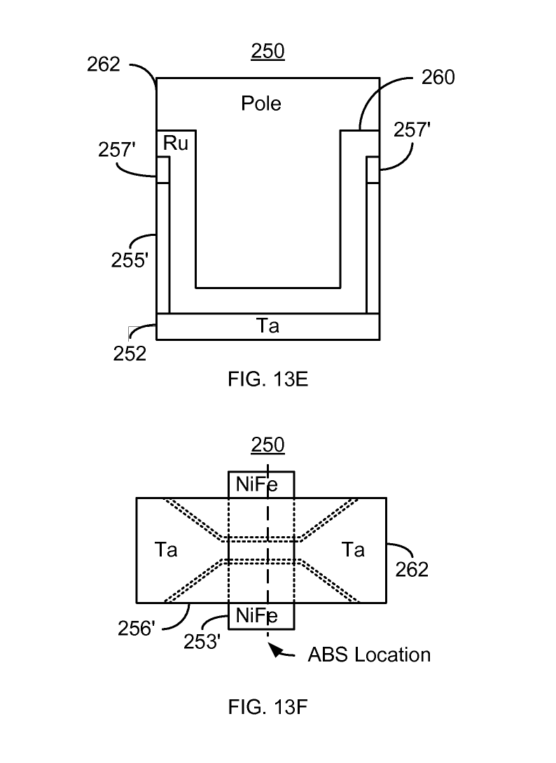

At least one magnetic pole material is plated, via step 224. In other embodiments, step 224 may be performed using sputtering or other deposition techniques. Further, multiple materials, including nonmagnetic materials, may be used in forming the pole. In addition, in some embodiments a separate seed layer (not shown) is used. FIGS. 13A, 13B, 13C, 13D, 13E and 13F depict side, ABS, two intermediate, yoke and plan views of the transducer 250 after step 224 is performed. In the embodiment shown in FIGS. 13A-F, the second nonmagnetic gap layer 260 is utilized. Pole material 262 is also shown. The pole material 262 fills the remaining portion of the pole trench 258″. Also in the embodiment shown, a portion of the pole material 262 is outside of the pole trench 258″. Also note that the pole trench 258′″ is not labeled in FIGS. 13A-13F.

The magnetic pole material 262 is planarized, via step 226. Thus, the portion of the pole material 262 outside of the pole trench 258″′ is removed. FIGS. 14A, 14B, 14C, 14D, 14E and 14F depict side, ABS, two intermediate, yoke and plan views of the transducer 250 after step 226 is performed. Thus, the pole 262′ remains. Because the pole 262′ is formed in the pole trench 258″′ in the side shield layer 254′, the pole 262′ may be considered to be formed using a damascene process.

A write gap is provided, via step 228. At least part of the write gap is on the pole 262′. Step 228 may include depositing at least one nonmagnetic write gap layer. In some embodiments, a portion of the nonmagnetic write gap distal from the pole may be removed.

A trailing shield may optionally be provided, via step 230. At least a portion of the trailing shield is on the write gap. In some embodiments, the trailing shield is physically and magnetically connected to the side shield 254′. In other embodiments, the trailing shield is physically and magnetically separated from the side shields.

Thus, using the method 200, the transducer 250 may be fabricated. The transducer 250 shares the benefits of the transducer 150. More specifically, fabrication and performance of the transducer 250 may be improved.

We claim:

1. A method for fabricating a magnetic transducer having an air-bearing surface location (ABS location) corresponding to an air-bearing surface (ABS), the method comprising:
providing an etch stop layer;
providing a nonmagnetic etchable layer on the etch stop layer;
providing a side shield layer residing between the ABS location and the etch stop layer and between the ABS location and the etchable layer;
removing a first portion of the side shield layer and first portion of the nonmagnetic etchable layer using a first removal process, thereby forming a first portion of a pole trench, the first portion of the pole trench having a bottom and a top wider than the bottom in the side shield layer;
removing at least a second portion of the nonmagnetic etchable layer using a second removal process, thereby forming the pole trench, the pole trench having a pole trench bottom and a pole trench top wider than the pole trench bottom in the side shield layer and a substantially perpendicular sidewalls in the nonmagnetic etchable layer;
providing a nonmagnetic side gap layer, at least a portion of the nonmagnetic side gap layer residing in the pole trench, a remaining portion of the pole trench having a location and profile for a pole;
forming the pole, at least a portion of the pole residing in the remaining portion of the pole trench;
providing a write gap, at least a portion of the write gap being on the pole; and
providing a trailing shield, at least a portion of the trailing shield being on the write gap.

2. The method of claim 1 further comprising:
providing a hard mask, the hard mask having an aperture therein corresponding to the pole trench.

3. The method of claim 2 wherein the hard mask includes at least one of Ti and Ta.

4. The method of claim 1 wherein the side shield layer includes NiₓFe₁₋ₓ where x is at least 0.17 and not more than 0.7.

5. The method of claim 1 wherein the etch stop layer includes Ta.

6. The method of claim 1 wherein the etchable layer includes SiO₂.

7. The method of claim 1 further comprising:
providing a nonmagnetic layer on the nonmagnetic etchable layer and on the side shield layer, wherein the first removal process removes a first portion of the nonmagnetic layer and the second removal process removes a second portion of the nonmagnetic layer above the nonmagnetic etchable layer

8. The method of claim 7 wherein the nonmagnetic layer includes NiCr.

9. The method of claim 1 wherein the first removal process further includes: a reactive ion etch utilizing a NiFe etch chemistry.

10. The method of claim 1 wherein the second removal process further includes a reactive ion etch utilizing SiO₂ etch chemistry.

11. The method of claim 1 wherein the nonmagnetic etchable layer is at least twenty and not more than sixty nanometers from the ABS location.

12. A method for fabricating a magnetic transducer having an air-bearing surface location (ABS location) corresponding to an air-bearing surface (ABS), the method comprising:
providing an etch stop layer including Ta;
providing a nonmagnetic etchable layer on the etch stop layer, the nonmagnetic etchable layer including SiO₂, the nonmagnetic etchable layer terminating at least twenty nanometers and not more than sixty nanometers from the ABS location;
providing a side shield layer residing between the ABS location and the etch stop layer and between the ABS location and the etchable layer, the side shield layer including NiFe;
removing a first portion of the side shield layer and first portion of the nonmagnetic etchable layer using a first removal process, thereby forming a first portion of a pole trench, the first portion of the pole trench having a bottom and a top wider than the bottom in the side shield layer, the first removal process including a first reactive ion etch utilizing a NiFe etch chemistry;
removing at least a second portion of the nonmagnetic etchable layer using a second removal process, thereby forming the pole trench, the pole trench having a pole trench bottom and a pole trench top wider than the pole trench bottom in the side shield layer and a substantially perpendicular sidewalls in the nonmagnetic etchable layer, the second removal process including a second reactive ion etch utilizing SiO₂ etch chemistry;
providing a nonmagnetic side gap layer, at least a portion of the nonmagnetic side gap layer residing in the pole trench, a remaining portion of the pole trench having a location and profile for a pole;
forming the pole, at least a portion of the pole residing in the remaining portion of the pole trench;
providing a write gap, at least a portion of the write gap being on the pole; and
providing a trailing shield, at least a portion of the trailing shield being on the write gap.
